(19) United States
(12) Patent Application Publication
(10) Pub. No.: US 2006/0257704 A1
(43) Pub. Date: Nov. 16, 2006

(54) Fuel cell

(75) Inventors: Shigeru Ogino, Toyota-shi (JP); Satoshi Aoyama, Susono-shi (JP); Satoshi Shiokawa, Susono-shi (JP); Takashi Shimazu, Nagoya-shi (JP); Hiroshi Aoki, Nagoya-shi (JP); Hiroyuki Mitsui, Nagoya-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 11/442,243

(22) Filed: May 30, 2006

Related U.S. Application Data
(63) Continuation of application No. PCT/JP04/17181, filed on Nov. 18, 2004.

(30) Foreign Application Priority Data
Nov. 28, 2003 (JP) 2003-400255

(51) Int. Cl. H01M 8/10; H01M 8/04

(52) U.S. Cl. 429/30; 429/26; 429/38

(57) ABSTRACT

A fuel cell is made by laminating an anode channel 2 supplied with hydrogen or a hydrogen-containing gas g_{H}, a cathode channel 3 supplied with oxygen or an oxygen-containing gas G_{O}, and an electrolyte 4 arranged between the cathode channel and the anode channel. The electrolyte 4 is made by laminating a hydrogen separating metal layer for making hydrogen supplied to the anode channel 2 or hydrogen in a hydrogen-containing gas G_{H} supplied to the anode channel 2 permeate; and a proton conductor layer made of ceramics, for establishing the hydrogen having permeated the hydrogen separating metal layer in a proton state and making it reach the cathode channel 3. In addition, the fuel cell has a coolant channel 5 for cooling the fuel cell 1. In the coolant channel 5, a low heat conducting section 55 having a heat conductivity smaller than that at a downstream side of a coolant C is formed at an inlet side of the coolant C.

### CROSS-REFERENCES TO RELATED APPLICATIONS

This application is a continuation of Application PCT/JP2004/017181, filed Nov. 18, 2004 which claims priority under 35 U.S.C.§119 to Japanese Patent Application No. 2003-400255, filed Nov. 28, 2003, entitled “FUEL CELL”. The contents of this application are incorporated herein by reference in their entirety.

### TECHNICAL FIELD

The present invention relates to a fuel cell for generating electric power by utilizing hydrogen and oxygen. In particular, the present invention relates to a fuel cell comprising a coolant channel for cooling the battery.

### BACKGROUND ART

A fuel cell system for generating electric power by utilizing a hydrocarbon fuel or the like comprises a reformer for generating a hydrogen-containing gas from a hydrocarbon fuel or the like, a hydrogen separating membrane device for removing hydrogen with high purity from the hydrogen-containing gas, and a fuel cell for generating electric power by establishing hydrogen in a hydrogen proton state and reacting it with oxygen. The reformer carries out a vapor reforming reaction with a hydrocarbon fuel and water and a partial oxidization reaction with a hydrocarbon fuel and oxygen, thereby generating the hydrogen-containing gas. In addition, the hydrogen separating membrane device comprises a hydrogen separating membrane that consists of palladium or vanadium, and this hydrogen separating membrane has property that only hydrogen is permeated. In addition, the fuel cell has an anode channel to which hydrogen having permeated the hydrogen separating membrane, a cathode channel supplied with an oxygen-containing gas such as oxygen or air, and a proton conductor (electrolyte) arranged between these channels.

In addition, in the fuel cell system, electric power is generated while the hydrogen supplied to the anode channel is established in a hydrogen proton state by permeating the proton conductor and this hydrogen proton and oxygen are reacted with each other and water is generated in the cathode channel. Such a fuel cell system is disclosed in patent documents 1 and 2, for example.

In addition, types of fuel batteries include a solid polymeric membrane type fuel cell using a solid polymer membrane as the proton conductor, a phosphoric acid type fuel cell using immersion of phosphoric acid in silicone carbide as the proton conductor, or the like. In the reformer, reaction is carried out at a high temperature equal to or higher than 400° C., for example, in order to restrict precipitation of carbon. On the other hand, the batteries have property that they must be used. Thus, an operating temperature of each of the fuel batteries is within the range of 20° C. to 120° C. in solid polymeric membrane type fuel cell and is within the range of 120° C. to 210° C. in a phosphoric acid type fuel cell because they must be used while the proton conductor is immersed with water.

That is, a temperature of the hydrogen-containing gas generated by the reformer and a temperature of the hydrogen having permeated the hydrogen separating membrane become remarkably higher than a temperature of the hydrogen supplied to the fuel cell. Therefore, in the described conventional fuel cell system, there has been a need for significantly lowering the temperature no later than hydrogen has been supplied to the fuel cell.

Specifically, in patent document 1, heat exchange between the hydrogen-containing gas generated in the reformer and a cathode offgas is carried out by means of a heat exchanger, whereby heat quantity is provided from the hydrogen-containing gas to the cathode offgas and a temperature of this hydrogen-containing gas is lowered. In addition, the temperature of the hydrogen having permeated the hydrogen separating membrane is further lowered by means of another heat exchanger, and then, the resulting hydrogen is supplied to the fuel cell.

In addition, in patent document 2, the hydrogen having permeated the hydrogen separating membrane is made to pass through a condenser, whereby a temperature of this hydrogen is lowered, and then, the resulting hydrogen is supplied to the fuel cell.

As described above, in the above described conventional fuel cell system, there has been a need for using a device(s) such as the heat exchangers or the condenser. As a result, in the conventional fuel cell system, there has been a problem that an energy loss occurs and a configuration of the above described fuel cell system becomes complicated.

In addition, in a fuel cell, heat is generated due to its battery reaction. However, as described above, a range of a drive temperature of the fuel cell is determined depending on a type or the like of its proton conductor. Therefore, a coolant for cooling the fuel cell is supplied to the fuel cell in order to maintain a temperature of the fuel cell in a predetermined range, and a coolant channel for that purpose is provided.

However, when temperature control is carried out while supplying the coolant to the coolant channel, a temperature difference occurs between an inlet and an outlet of the coolant, and deviation is likely to occur in temperature distribution of the fuel cell. Specifically, when the coolant is introduced to the coolant channel, a temperature difference between the coolant and its periphery is large at the inlet side of the coolant, and thus, excessive cooling is likely to occur. At the outlet side, a temperature difference between the coolant and its periphery is small, and cooling is likely to be insufficient. As a result, at the inlet side and outlet side of the coolant, deviation is likely to occur in temperature distribution of the fuel cell.

Therefore, for example, as disclosed in patent documents 3 to 7 described below, development has been made to progress in order to eliminate the deviation in temperature distribution of the fuel cell.

In patent document 3, there is disclosed a fuel cell cooling plate in which a fluororesin tapered pipe has been inserted into a cooling gas channel interposed in a battery stack. The tapered pipe is thus inserted, thereby making it possible to reduce a temperature difference between an inlet and an outlet of a cooling gas.

In addition, in patent document 4, there is disclosed a laminated layer type fuel cell having mounted on the coolant channel in the cell therein a combustion catalyst that functions as an oxidization heating catalyst at the time of startup and that functions as a cooling gas flow rate resistor at the time of operation. By using such a catalyst, the deviation in temperature distribution in the laminate direction of the fuel cell can be reduced.

Further, in patent document 5, there is disclosed a fuel cell system in which a cooling gas channel for opposing a cathode flow has been formed between a cathode gas channel and a separator.

In addition, in patent document 6, there is disclosed a fuel cell control device comprising: a first manifold housed by integrating an inlet side of a cooling gas channel with an outlet side of an oxidizing agent gas channel; and a second manifold housed by integrating an outlet side of a cooling gas channel and an inlet side of an oxidizing agent gas channel, wherein a flow rate of the oxidizing agent gas and the cooling gas can be individually controlled in accordance with a set temperature condition.

Further, in patent document 7, there is disclosed a fuel cell cooling plate in which small protrusions orthogonal or oblique to a cooling gas distribution direction are disposed at predetermined gaps on an internal wall of a coolant channel.

However, cooling means disclosed in patent documents 3 to 7 have had the problems described below, respectively.

That is, in patent document 3, there is a need for inserting a tapered pipe into a cooling pas channel. However, in general, a fuel cell is made of several hundreds of laminates of a separator, and a plenty of, for example, several hundreds of channels are formed per one separator. Thus, it is actually very difficult to insert the tapered pipe described in patent document 3 into each channel. In addition, a pipe having been inserted into a cooling gas inlet passage precludes the flow of a coolant, and thus, a pressure loss increases, and a loss of supply drive force of a fluid such as a cooling gas increases. As a result, there occurs a problem that energy efficiency of a fuel cell system is lowered.

In addition, in the fuel cell of patent document 4, there is a need for charging each coolant channel with a catalyst. Therefore, there has been a problem that a manufacturing process becomes complicated.

In addition, in the fuel cell using such a catalyst, there has been a problem that the deviation of temperature distributions in the fuel cell cannot be sufficiently reduced.

In addition, in the fuel cell system of patent document 5 as well, there has been a problem that the deviation of temperature distributions in the fuel cell cannot be sufficiently reduced. That is, in such a fuel cell system, there has been a danger that a temperature increases at an end of a cooling gas channel and a temperature decreases at a center of the channel.

In addition, in the cooling means described in patent document 6 and patent document 7 as well, the deviation of temperature distribution in the fuel cell cannot be sufficiently reduced.

In particular, when using the cooling plate on which small protrusions have been provided, as described in patent document 7, the height of a channel in a fuel cell is very small, several hundreds of microns, in general, and thus, a disturbance effect due to such small protrusions hardly occurs. Thus, a heat transfer promotion effect can be hardly attained, and the deviation of the temperature distributions has not been sufficiently eliminated successfully.
Patent document 1: JP 2003-151599 Unexamined Patent Publication (Kokai)
Patent document 2: JP 2001-223017 Unexamined Patent Publication (Kokai)
Patent document 3: JP S64-77874 Unexamined Patent Publication (Kokai)
Patent document 4: JP S63-188865 Unexamined Patent Publication (Kokai)
Patent document 5: JP H11-283638 Unexamined Patent Publication (Kokai)
Patent document 6: JP S63-276878 Unexamined Patent Publication Kokai)
Patent document 7: JP H2-129858 Unexamined Patent Publication (Kokai)

### DISCLOSURE OF THE INVENTION

Problems to be Solved by the Invention

In view of the conventional problems, the present invention has been developed, and an object of the present invention to provide a fuel cell capable of simplifying a configuration of a fuel cell system, capable of improving energy efficiency of the system, and capable of reducing deviation of temperature distributions.

Means of Solving the Problems

The first aspect of the present invention relates to a fuel cell made by laminating an anode channel supplied with hydrogen or a hydrogen-containing gas;

a cathode channel supplied with oxygen or an oxygen-containing gas; and

an electrolyte arranged between the cathode channel and the anode channel,

wherein the electrolyte is made by laminating: a hydrogen separating metal layer for being permeated by hydrogen supplied to the anode channel or hydrogen in a hydrogen-containing gas supplied to the anode channel; and a proton conductor layer made of ceramics, for establishing the hydrogen having permeated the hydrogen separating metal layer in a proton state and making the proton reach the cathode channel;

wherein the fuel cell has a coolant channel for cooling the fuel cell, and, at an inlet side of the coolant in the coolant channel, a Low heat conducting section whose heat conductivity is smaller than that at a downstream side thereof is formed; and

wherein the low heat conducting section is formed by providing a replacement restricting section for restricting replacement of a coolant at an inlet side of the coolant channel.

The second aspect of the present invention relates to a fuel cell made by laminating an anode channel supplied with hydrogen or a hydrogen-containing gas;

a cathode channel supplied with oxygen or an oxygen-containing gas; and

an electrolyte arranged between the cathode channel and the anode channel,

wherein the electrolyte is made by laminating: a hydrogen separating metal layer for being permeated by hydrogen supplied to the anode channel or hydrogen in a hydrogen-containing gas supplied to the anode channel; and a proton conductor layer made of ceramics, for establishing the hydrogen having permeated the hydrogen separating metal layer in a proton state and making the proton reach the cathode channel;

wherein the fuel cell has a coolant channel for cooling the fuel cell, and, at an inlet side of the coolant in the coolant channel, a low heat conducting section whose heat conductivity is smaller than that at a downstream side thereof is formed; and

wherein the coolant channel has a side face inlet for introducing a coolant from a side face of a downstream side thereof.

The third aspect of the present invention relates to a fuel cell made by laminating an anode channel supplied with hydrogen or a hydrogen-containing gas;

a cathode channel supplied with oxygen or an oxygen-containing gas; and

an electrolyte arranged between the cathode channel and the anode channel,

wherein the electrolyte is made by laminating: a hydrogen separating metal layer for being permeated by hydrogen supplied to the anode channel or hydrogen in a hydrogen-containing gas supplied to the anode channel; and a proton conductor layer made of ceramics, for establishing the hydrogen having permeated the hydrogen separating metal layer in a proton state and making the proton reach the cathode channel;

wherein the fuel cell has a coolant channel for cooling the fuel cell, and, at an inlet side of the coolant in the coolant channel, a low heat conducting section whose heat conductivity is smaller than that at a downstream side thereof is formed; and

wherein the coolant channel has a partition wall for partitioning a coolant flowing direction into a plurality of units, and wherein an introducing inlet for introducing a coolant and an exhaust outlet for discharging a coolant are arranged at each unit, respectively.

In the fuel cell according to the present invention, the electrolyte has the proton conductor layer made of ceramics such as a perovskite-based one, for example, and such a proton conductor layer does not need water in proton conduction. Thus, the fuel cell can be actuated at a high temperature ranging from 300° C. to 600° C., for example.

In addition, in the present invention, the electrolyte is made by laminating the hydrogen separating metal layer and the proton conductor layer. Thus, unlike a conventional case, there is no need for separately providing a hydrogen separating metal and a fuel cell, and its configuration can be simplified and the hydrogen or hydrogen-containing gas supplied from a reformer or the like, for example, can be directly supplied to the fuel cell.

In addition, in the fuel cell of the present invention, as described above, the operating temperature of the fuel cell can be set at a high temperature. Thus, a temperature of the hydrogen or hydrogen-containing gas supplied from the reformer or the like and an operating temperature of the fuel cell can be set to be substantially equal to each other. Thus, in the present invention, between the reformer and the fuel cell, there is no need for providing a heat exchanger and a condenser or the like which is required because of a temperature difference between them. Thus, an energy loss caused by using these can be eliminated, and energy efficiency can be improved. Therefore, when a fuel cell system is configured by combining the fuel cell with another device such as the reformer, its configuration can be simplified, and energy efficiency can be improved.

In addition, the fuel cell according to the present invention has a low heat conducting section having a small heat conductivity at an inlet side of a coolant in the coolant channel.

The low heat conducting section is formed at the inlet side of the coolant channel, and the heat conductivity is smaller than that at the downstream side of the coolant channel. Thus, when the coolant has been supplied to the coolant channel, heat transfer at the inlet side can be restricted, and excessive cooling at the inlet side can be prevented. Therefore, the cooling using the coolant in the fuel cell can be uniformly carried out, and the deviation of the temperature distributions can be prevented.

That is, in general, in the fuel cell comprising the coolant channel, when the coolant has been introduced to the coolant channel, a temperature difference at the inlet side of the coolant channel becomes the greatest, and excessive cooling at the inlet side is likely to occur. As a result, a temperature difference between the inlet side and the downstream side of the coolant channel increases, and deviation occurs in the temperature distributions.

In the present invention, as described above, the low heat conducting section is provided at the inlet side of the coolant channel. Thus, heat transfer at the inlet side of the coolant is restricted, and excessive cooling at the inlet side is prevented, thereby making it possible to prevent the deviation of the temperature distributions in the coolant channel.

In addition, in the present invention, the electrolyte is made by laminating the hydrogen separating metal layer and the proton conductor layer, as described above. Thus, in the case where deviation occurs in temperature distribution, and then, the temperature is out of the range of an operating temperature, there is a danger that the hydrogen separating metal layer made of such as palladium or vanadium and the like deteriorates and battery performance is degraded. In addition, since an electrically conducting resistance of the proton conductor layer has temperature dependency and in general, the electrically conducting resistance of the proton conductor layer increases in a low temperature region. There is a danger that the deviation in the low temperature direction causes lowering of electric power generation efficiency. In the fuel cell according to the present invention, the low heat conducting section is formed at the inlet side of the coolant channel, and thus, the deviation in the temperature distributions hardly occurs, and deterioration of the hydrogen separating metal layer or lowering of the electric power generation efficiency can be prevented.

In addition, the hydrogen separating metal layer is permeated by hydrogen supplied to the anode channel or hydrogen from the hydrogen-containing gas supplied to the anode channel. Then, the hydrogen having permeated the hydrogen separating metal layer is established in a proton state, permeates the proton conductor layer, and reaches the cathode channel. In the cathode channel, the oxygen contained in the oxygen-containing gas supplied to the cathode channel and the hydrogen proton (called H⁺, hydrogen ion) are reacted with each other to generate water. In the fuel cell, for example, by forming the anode electrode and the cathode electrode are formed on the electrolyte, it possible to acquire electric energy between the anode electrode and the cathode electrode along with the water generation as described above.

As described above, according to the present invention, there can be provided a fuel cell capable of simplifying a configuration of the fuel cell system, capable of improving energy efficiency of the system, and capable of reducing the deviation in temperature distribution.

### BRIEF DESCRIPTION OF THE DRAWINGS

FIG. 1 is a perspective view showing a configuration of a fuel cell according to a first embodiment;

FIG. 2 is a partial cross section showing a configuration of an electrolyte in the fuel cell according to the first embodiment;

FIG. 3 is a sectional view of the fuel cell showing a configuration of a coolant channel according to the first embodiment;

FIG. 4 is a sectional illustrative view illustrating a configuration of a fuel cell in which a hollow section has been formed in a wall of a coolant channel, according to a second embodiment;

FIG. 5 is a sectional illustrative view illustrating a configuration of a fuel cell in which a replacement restricting section has been formed by forming a hollow section having an opening in a wall of a coolant channel, according to a third embodiment;

FIG. 6 is an illustrative view illustrating a flow of a heating gas when the heating gas has been introduced to the coolant channel in which the hollow section having the opening has been formed, according to the third embodiment;

FIG. 7 is a perspective view showing a configuration of a coolant channel having a bulkhead arranged therein, according to a fourth embodiment;

FIG. 8 is a perspective view showing a configuration of the coolant channel having arranged therein a bulkhead whose thickness has been inclined at its inside, according to the fourth embodiment;

FIG. 9 is a plan view when the coolant channel having a protrusive bulkhead arranged therein is seen from above, according to the fourth embodiment;

FIG. 10 is a perspective view showing a configuration of a coolant channel in which a bulkhead has been further arranged in a channel separated by the bulkhead, at the downstream side of the coolant channel, according to the fourth embodiment;

FIG. 11 is a perspective view showing a configuration of a coolant channel in which a bulkhead has been further arranged in only one or more of the flow channels separated by the bulkhead, at the downstream side of the coolant channel, according to the fourth embodiment;

FIG. 12 is a perspective view showing a configuration of a coolant channel in which a separating wall for separating a flow channel expanding section in a direction substantially vertical to a laminated direction of an anode channel, a cathode channel, and an electrolyte has been arranged at the flow channel expanding section, according to the fourth embodiment;

FIG. 13 is a plan view when a coolant channel forming a communicating section by cutting a bulkhead at an inlet side of the coolant channel is seen from above, according to a fifth embodiment;

FIG. 14 is a sectional illustrative view of a fuel cell, illustrating a coolant channel in which a communicating section has been formed by forming a slit on the bulkhead at the inlet side of the coolant channel, according to the fifth embodiment;

FIG. 15 is a sectional illustrative view of the fuel cell, illustrating a coolant channel in which a communicating section has been formed by forming a plurality of holes on the bulkhead at the inlet side of the coolant channel, according to the fifth embodiment;

FIG. 16 is a sectional illustrative view of a fuel cell in which a spaced section has been formed between a bulkhead and an internal wall of a coolant channel, according to a sixth embodiment;

FIG. 17 is a sectional illustrative view of a fuel cell having a coolant channel in which a section at the inlet side of the coolant channel on a bulkhead is partially formed of a low heat conducting material, according to a seventh embodiment;

FIG. 18 is a plan view when a coolant channel having a side face inlet on a side face and having a serial flow channel is seen from above, according to an eighth embodiment;

FIG. 19 is a plan view when a coolant channel being partitioned into a plurality of units on a partition wall and having a parallel flow channel is seen from above, according to a ninth embodiment;

FIG. 20 is a plan view when a coolant channel having formed an interrupt wall by a flow channel separated on a bulkhead is seen from above, according to a tenth embodiment;

FIG. 21 is a plan view when a coolant channel is seen from above, the coolant channel forming an interrupt wall in a flow channel separated by a bulkhead, and the interrupt wall being partially formed by a coolant resistance material, according to the tenth embodiment:

FIG. 22 is a plan view when a coolant channel is seen from above, the coolant channel forming an interrupt wall in a flow channel separated by a bulkhead and forming a collimating hole on the interrupt wall, according to the tenth embodiment;

FIG. 23 is a plan view when a coolant channel formed of a single flow channel is seen from above, according to an eleventh embodiment;

FIG. 24 is a plan view when a coolant channel made of a single flow channel and forming an interrupt wall is seen from above, according to the eleventh embodiment;

FIG. 25 is a plan view when a coolant channel is seen from above, the coolant channel being made of a single flow channel and having an interrupt wall partially formed of a flow rate resistance material; and

FIG. 26 is a plan view when a coolant channel is seen from above, the coolant channel being made of a single flow channel and forming an interrupt wall that has a collimating hole.

### BEST MODE FOR CARRYING OUT THE INVENTION

Now, preferred embodiments of a fuel cell according to the present invention will be described here.

In the present invention, the fuel cell is made by laminating the anode channel, the cathode channel, and the electrolyte.

In addition, the fuel cell according to the present invention can be configured by further laminating a plurality of unit battery cells, each of which is made of the anode channel, the cathode channel, and the electrolyte. In this case, for example, the unit battery cells and the coolant channels are alternately laminated so that each unit battery cell can be cooled, whereby a plurality of the coolant channel can be formed.

In addition, the electrolyte is made by laminating the hydrogen separating metal layer and the proton conductor layer. As the hydrogen separating metal layer, there can be used a laminate membrane or the like of palladium (Pd) and vanadium (V), for example. In addition, a membrane made of palladium (Pd) can also be used solely, and a palladium alloy or the like can also be used.

In addition, as the proton conductor layer, for example, there can be used a perovskite-based electrolytic membrane or the like. The perovskite-based electrolytic membranes include BaCeO₃-based membrane and SrCeO₃-based membrane or the like, for example.

In addition, hydrogen or a hydrogen-containing gas is supplied to the anode channel. As this hydrogen or hydrogen-containing gas, there can be used a reformed gas obtained by reforming a hydrocarbon fuel with the use of a reformer or the like, for example. In the reformer, a reformed gas such as a hydrogen-containing gas can be generated by carrying out a water steam reforming reaction between the hydrocarbon fuel and water and a partial oxidizing reaction or the like between the hydrocarbon fuel and oxygen.

In addition, an oxygen-containing gas supplied to an anode channel includes oxygen or air and the like, for example.

In addition, as a coolant supplied to the coolant channel, for example, there can be used a water steam, air, the reformed gas, an offgas discharged after reaction in the fuel cell, and water or the like.

In addition, in the coolant channel, the low heat conducting section is formed at an inlet side when a coolant is introduced to the coolant channel. At the low heat conducting section, a heat conductivity is lower than that at the downstream side of the coolant in the coolant channel. Such a low heat conducting section can be formed by forming a heat insulating layer, a replacement restricting section, a hollow section, and an opening or by arranging a bulkhead in the coolant channel, as described later.

In addition, the coolant channel can be formed of stainless or the like, for example, a heat conductivity of stainless is about 10 W/m·K to 30 W/m·k. Therefore, the low heat conducting section can be formed by reducing the heat conductivity at the inlet side of the coolant channel, for example, to be smaller than 10 W/m·K. Preferably, this conducting rate should be set to 1 W/m·K or less.

Next, the low heat conducting section can be formed by providing a heat insulating layer on an internal wall of the inlet side of the coolant in the coolant channel.

In this case, a passing heat resistance at the inlet side of the coolant in the coolant channel can be increased. That is, in this case, the heat conductivity at the inlet side of the coolant channel can be reduced to be lower than that at the downstream side, and the low heat conducting section can be easily configured.

The heat insulating layer can be formed by coating or posting a low heat conducting material or a porous material having a heat conductivity of 10 W/m·K or less, for example, on the internal wall of the inlet side of the coolant channel. As such a low heat conducting material, for example, there can be used an oxide such as an aluminum oxide, a nitride, or ceramics and the like. In addition, a foaming metal or foaming ceramics can be used as a porous material. In particular, in the case where the heat insulating layer has been formed of a porous material, its flowing can be inhibited in a state in which a coolant is included. As a result, it becomes possible to reduce the heat conductivity of the porous material to a level of the included coolant.

In addition, the low heat conducting section can be formed by providing a hollow section in the wall of the inlet side of the coolant in the coolant channel.

In this way, by forming the hollow section in the wall of the inlet side of the coolant channel, the passing heat resistance at the inlet side can be increased. That is, by forming the hollow section in the wall of the inlet side of the coolant channel, the inlet side of the coolant channel is obtained as a configuration such as a thermos. As a result, the heat conductivity at the inlet side of the coolant channel can be reduced to be lower than that at the downstream side, and the low heat conducting section can be easily configured.

In addition, an opening that opens in the coolant channel can be formed in the hollow section. In this case, replacement, circulation, and flowing of the internal gas can be restricted, and the passing heat resistance at the inlet side can be increased. As a result, the heat conductivity at the inlet side of the coolant channel can be reduced to be lower than that at the downstream side, and the low heat conducting section can be easily configured.

Next, it is preferable that the low heat conducting section be formed by providing a replacement restricting section for restricting replacement of a coolant at the inlet side of the coolant channel.

In this case, the replacement of the coolant at the inlet side of the coolant channel can be restricted, and circulation and flowing of the coolant can be restricted. Thus, the coolant supplied into the coolant channel can be restricted from sequentially replaced at the inlet side of the coolant channel, and excessive cooling at the inlet side of the coolant channel can be prevented.

It is preferable that the replacement restricting section be formed by providing a hollow section provided in the wall of the inlet side of the coolant in the coolant channel and an opening that is provided in the hollow section and opens in the coolant channel. In this case, the replacement of the coolant at the inlet side of the coolant channel can be restricted by means of the hollow section having the opening. That is, in this case, the replacement restricting section can be easily achieved.

In addition, it is preferable that the opening be formed so that a section positioned at the inlet side of the coolant in the hollow section and a section positioned at the downstream side open in the coolant channel.

In this case, a heating gas is supplied to the coolant channel in an orientation opposite to the flow of the coolant, whereby the internal gas can be replaced and the opening can be utilized as an efficient heating fin. Further, at this time, a heat conducting area increases, thus making it possible to efficiently heat a fuel cell.

Next, it is preferable that bulkheads for separating the flow of the coolant be arranged to be substantially parallel to a flowing direction of the coolant in the coolant channel.

In this case, the deviation in internal flow distribution of the coolant in the coolant channel or the deviation due to gravity or the like can be prevented. The bulkheads can be arranged in plurality in the coolant channel.

In addition, the bulkheads can be formed of a metal thin film. In this case, the thickness of the bulkhead can be reduced, and thus, the heat capacity of the whole fuel cell hardly increases. Thus, a failure of an increase in heat capacity occurring at the time of fuel cell startup can be avoided.

As such a metal thin film, there can be used a thin film having excellent heat resistance and oxidization resistance, made of SUS316L, SUS304, Inconel, Hastelloy, a titanium alloy, a nickel alloy, and SUS430 or the like.

In addition, it is preferable that the flow channel of the coolant separated by the bulkheads have a flow channel expanding section where a flow channel gap at the inlet side is formed to be greater than that on the downstream side.

In this case, a sectional area at the inlet side of the flow channel separated by the bulkheads increases, and a heat conducting area at the inlet side can be reduced. In this manner, the heat conductivity at the inlet side of the coolant in the coolant channel is reduced so that the low heat conducting section can be easily formed.

In addition, as described above, in the case where the heat insulating layer, the hollow section having an opening, and the replacement restricting section are formed at the inlet side of the coolant channel, there is a danger that the flow channel resistance (collocation loss) at the inlet side of the coolant channel increases, and a coolant motivity loss slightly increases. Therefore, in this case, the flow channel expanding section is formed together with the heat insulating layer, the hollow section, and the replacement restricting section, whereby an increase in flow channel resistance can be prevented.

In addition, the flow channel expanding section can be formed by reducing the number of the bulkheads at the inlet side more significantly than that at the downstream side and reducing the number of flow channels at the inlet side more significantly than that at the downstream side so that a flow channel gap at the inlet side in the coolant channel is greater than that at the downstream side. In addition, the flow channel expanding section can be formed by arranging a bulkhead at the downstream side without arranging the bulkhead at the inlet side of the coolant channel. Further, the flow channel expanding section can also be formed by reducing the thickness of the bulkhead at the inlet side and increasing the thickness of the bulkhead at the downstream side to be greater than that at the inlet side.

Next, it is preferable that the flow channel expanding sections be formed in one or more of the flow channel separated by the bulkheads, and the flow channel expanding section not be formed in the remaining ones of the separated flow channels.

If the flow channel expanding section is formed in all of the flow channels separated on the bulkheads, there is a danger that a pressure loss increases when a coolant has been supplied. From among the flow channels separated by the bulkheads, the flow channel expanding sections are formed in one or more of these flow channels, whereby excessive cooling at the inlet side in the coolant channel can be prevented while an increase in pressure loss is reduced to the minimum.

In addition, in the flow channel expanding section, it is preferable that a separating wall for separating the flow channel expanding section be formed in a direction which is substantially vertical to a laminate direction of the anode channel, the cathode channel, and the electrolyte.

In this case, a heat flow in a heat flow direction, i.e., in the laminate direction, is restricted, and the heat flow in a plane which is substantially orthogonal to the heat flow direction can be promoted. Thus, a temperature difference in a plane substantially orthogonal to the heat flow direction can be reduced, and excessive cooling at the inlet side in the coolant channel can be prevented. The separating walls can be formed in plurality.

In addition, it is preferable that the bulkhead have a communicating section that communicates a flow channel separated by the bulkhead.

In this case, a fin effect at the inlet side of the coolant channel can be reduced. As a result, an expanded heat transmission area at the inlet side can be reduced, and the heat transmission property can be lowered. That is, in this case, the low heat conducting section can be easily formed at the inlet side of the coolant channel.

The communicating section can be formed by spacing and arranging the bulkhead at the inlet side of the coolant channel, for example, in the coolant flow direction. In this case, a fin area in a heat flow direction is reduced, and the expanded heat transmissibility area can be reduced.

In addition, the communicating section can be formed by providing a slit on the bulkhead in the coolant flow direction. In this case, a fin internal heat flux in the heat flow direction is broken by means of the slit so that the heat transmissibility area can be reduced and the fin efficiency can be remarkably reduced.

Further, the communicating section can be formed by forming one or more holes on the bulkhead. In this case, the fin internal heat flux in the heat flow direction is broken by means of the holes formed on the bulkhead so that the heat transmissibility area can be reduced.

Next, at the inlet side of the coolant channel, it is preferable that a spaced section at which the bulkhead is spaced from an internal wall of the coolant channel be formed at least at a section at which the bulkhead and the coolant channel come into contact with each other.

In this case, the fin internal heat flux at the inlet side of the coolant channel is broken so that the fin efficiency at the inlet side of the coolant channel can be reduced. As a result, an actual heat transmissibility area can be reduced, and the heat transmissibility at the inlet side of the coolant channel can be lowered. That is, in this case, the low heat conducting section can be easily formed at the inlet side of the coolant channel.

Next, it is preferable that a section at the inlet side of the coolant channel of the bulkhead be configured so that the heat conductivity becomes lower than a section at the downstream side thereof.

In this case, the fin efficiency at the inlet side of the coolant channel can be reduced. As a result, the heat transmissibility area at the inlet side can be reduced, and the heat transmissibility at the inlet side in the coolant channel can be lowered. That is, in this case, the low heat conducting section can be easily formed at the inlet side of the coolant channel.

As a method for reducing the heat conductivity at the inlet side of the bulkhead to be lower than that at the downstream, there is provided a method for composing a section at the inlet side of the bulkhead of a low heat conduction material. In addition, there is a method for coating or posting a low heat conduction material at a section at the inlet side of the bulkhead.

Such low heat conduction materials include, for example, a ceramics, a glass, a foam metal, and a foam ceramics or the like.

Next, at a side face at the downstream side from the inlet side, it is preferable that the coolant channel have a side face inlet for introducing a coolant from the side face.

In this case, a coolant can be introduced from the side face inlet formed on the side face at the downstream side while the coolant introduced from the side face inlet joins with a coolant from the inlet side of the coolant channel to flow. That is, the coolant channel is obtained as a serial flow channel. Thus, in the coolant channel, a coolant flow rate at the downstream side can be increased. That is, at the inlet side (upstream side) of the coolant channel, a coolant flow rate can be decreased more significantly than that at the downstream side. The lowering of the heat transmissibility at the inlet side can be promoted. The side face inlet can be formed in plurality.

In addition, in this case, a heat capacity flow rate can be lowered, and a coolant liquid membrane temperature can be risen. As a result, excessive cooling at the inlet side of the coolant channel can be prevented. Here, the coolant liquid membrane temperature is obtained as a typical temperature of a coolant calculated from a bulkhead temperature and a coolant temperature, and a temperature difference at the time of calculation of a heat transmissibility quantity is obtained from the coolant liquid membrane temperature and bulkhead temperature.

Further, in this case, a coolant flow rate at the inlet side can be reduced or stopped under a low output condition in which a coolant load is small. A coolant is supplied only from the side face inlet, and then, a center or later of the coolant channel can be intensively cooled. As a result, even in the case where an output level of the fuel cell has changed to a wide range, uniform temperature distribution can be easily achieved.

In addition, it is preferable that the coolant channel have a partition wall for partitioning a coolant flowing direction into a plurality of units, and that an introducing inlet for introducing a coolant and an exhaust outlet for discharging a coolant be arranged at each unit, respectively.

In this case, in each of the above described units, a coolant can be supplied and discharged independently, and a parallel flow channel can be formed as the coolant channel. In this manner, the temperature distribution in the coolant channel can be arbitrarily set. Specifically, for example, a coolant flow rate at the inlet side of a coolant channel in which excessive coolant is likely to occur can be reduced, and a coolant flow rate at the downstream at which cooling is unlikely to occur can be increased. Thus, the heat conductivity at the inlet side of the coolant channel can be lowered by controlling a coolant flow rate in each unit. In this case, the low heat conducting section can be easily formed.

Next, at least in one or more of the flow channel separated on the bulkhead, it is preferable that an interrupt wall for interrupting a flow of a coolant be arranged at the inlet side of the coolant channel.

In this case, a flow channel in which a coolant flows and a flow channel in which no current flows can be set in the flow channels separated by the bulkheads. That is, the interrupt wall is arranged at the inlet side of the coolant channel, and a flow channel in which no current flows is formed in one or more of the flow channels separated by the bulkheads, whereby heat exchanging capacity at the inlet side of the coolant channel can be lowered. In this manner, the low heat conducting section can be easily formed at the inlet side of the coolant channel.

In addition, it is preferable that a flow rate restricting section for limiting a coolant flow rate and making a coolant permeate be formed at least one or more of the interrupt wall.

In this case, a flow channel in which a coolant flow rate is large and a flow channel in which a coolant flow rate is small can be formed at the inlet side of the coolant in the coolant channel. In this manner, the heat exchange capacity at the inlet side of the coolant channel can be reduced, and the low heat conducting section can be easily formed. In addition, the flow rate restricting section is formed so that a large number of flow channels having a small coolant flow rate exists and so that a small number of flow channels having a large coolant flow rate exists. In this case, heat exchange capacity at the inlet side of the coolant channel can be reduced more effectively. This is because when the number of flow channels having a small coolant flow rate is increased and the number of flow channels having a large coolant flow rate is reduced, a heat transmissibility area of a flow channel having a small flow rate is increased; and a heat transmission area of a flow channel having a large coolant flow rate is reduced.

The flow rate restricting section can be formed by ensuring that at least part of the interrupt wall, for example, is formed of a flow rate resistance material for restricting a flow rate of the coolant and causing permeation. Such flow rate resistance materials include, for, example, a honeycomb, a porous material, a slit plate, and a punching metal or the like.

In addition, the flow rate restricting section can be formed by forming a collimating hole for restricting a flow rate of a coolant at least part of the interrupt wall, for example.

In addition, it is preferable that a communicating hole for re-distributing a coolant be provided at a section at the downstream side more than that at the inlet side of the coolant channel on the bulkhead.

In the case where the interrupt wall has been formed, there is a danger that the flow of the coolant at the downstream side from the inlet side of the coolant channel becomes uneven and that the deviation in temperature distribution occurs at the downstream side. Therefore, as described above, on the bulkhead, the communicating hole for re-distributing a coolant is provided at a section at the downstream side more significantly than that at the inlet side, whereby the non-uniformity of the coolant flow can be improved. As a result, the uniformity of the temperature distributions at the downstream side of the coolant channel can be promoted.

Next, the coolant channel can be formed of a single flow channel.

In this case, an internal flow distribution in the coolant channel can be spread in the direction substantially orthogonal to the coolant flow direction, and as a result, the internal flow distribution in the coolant channel can be uniformed. Forming the coolant channel as a single flow channel can be achieved, for example, by not arranging the bulkhead or the like in the coolant channel.

Further, in this case, it is preferable that protrusions which protrude inside of a coolant channel from an internal wall of the coolant channel be arranged in plurality in the coolant channel. In this manner, the dispersion property of the coolant in the coolant channel can be further improved.

In addition, it is preferable that an interrupt wall for interrupting part of the coolant flow at the inlet side of the coolant channel be arranged at the coolant channel.

In this case, a section at which a coolant flows and a section at which no coolant flows can be set at the inlet side of the coolant channel. In this manner, the heat exchange capacity at the inlet side of the coolant channel can be lowered by partially forming a section at which no coolant flows at the inlet side of the coolant channel. That is, the low heat conducting section can be easily formed at the inlet side of the coolant channel.

In addition, it is preferable that a flow rate restricting section for restricting a flow rate of a coolant and making a coolant permeate be formed at least at a part of the interrupt wall.

In this case, a section having a large flow rate of a coolant and a section having a small flow rate can be formed at the inlet side of the coolant in the coolant channel. The heat exchange capability at the inlet side of the coolant channel can be reduced by partially forming a section having a small flow rate of a coolant at the inlet side of the coolant channel. That is, the low heat conducting section can be easily formed at the inlet side of the coolant channel.

In addition, the flow rate restricting section is formed so that a large number of sections having a small coolant flow rate exists and a small number of sections having a large coolant flow rate exists. In this manner, the heat exchange capability at the inlet side of the coolant channel can be reduced more effectively.

### Embodiments

### First Embodiment

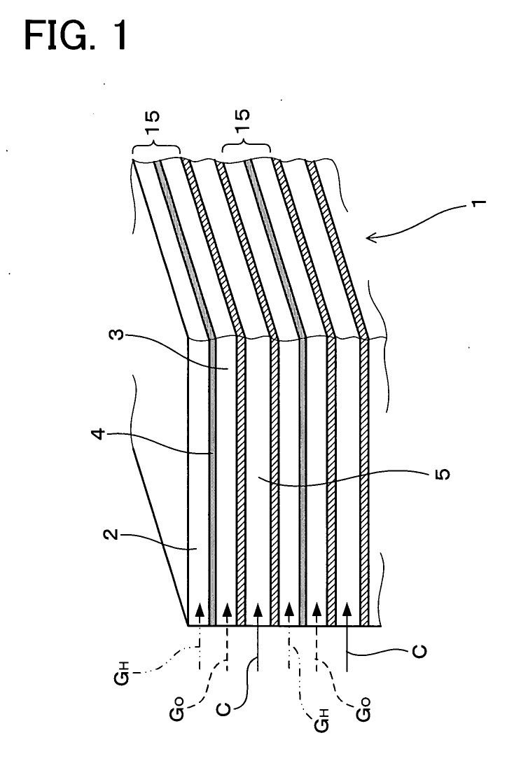

Now, a fuel cell according to an embodiment of the present invention will be described with reference to FIG. 1 to FIG. 3.

As shown in FIG. 1, a fuel cell 1 according to the present embodiment is made of a laminate of an anode channel 2 supplied with hydrogen or a hydrogen-containing gas G_{H}; a cathode channel 3 supplied with oxygen or an oxygen-containing gas G_{O}; and an electrolyte 4 arranged between the cathode channel 3 and the anode channel 2.

In addition, the fuel cell 1 according to the present embodiment is further made by laminating a plurality of unit battery cells 15 made by laminating an anode channel 2, an electrolyte 4, and a cathode channel 3.

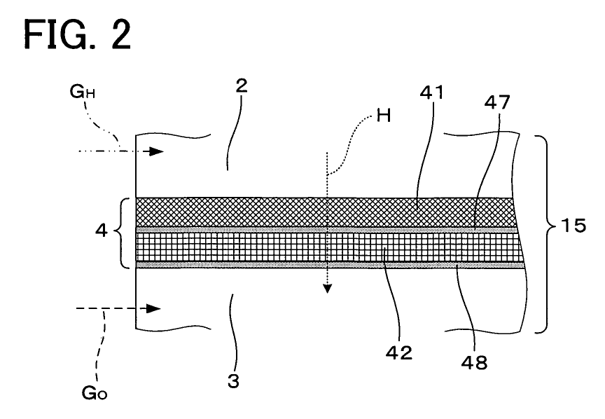

In addition, as shown in FIG. 2, the electrolyte 4 is made by laminating a hydrogen separating metal layer 41 for being permeated by hydrogen supplied to the anode channel 2 or hydrogen in the hydrogen-containing gas G_{H} supplied to the anode channel and a proton conductor layer 42 made of ceramics for establishing hydrogen H having permeated this hydrogen separating metal layer 41 in a proton state and making the proton reach the cathode flow rate 3.

In addition, as shown in FIG. 1, the fuel cell 1 has a coolant channel 5 for supplying a coolant C for cooling the battery. In the present embodiment, each coolant channel 5 is formed between unit battery cells 15 respectively in order to cool each unit battery cells.

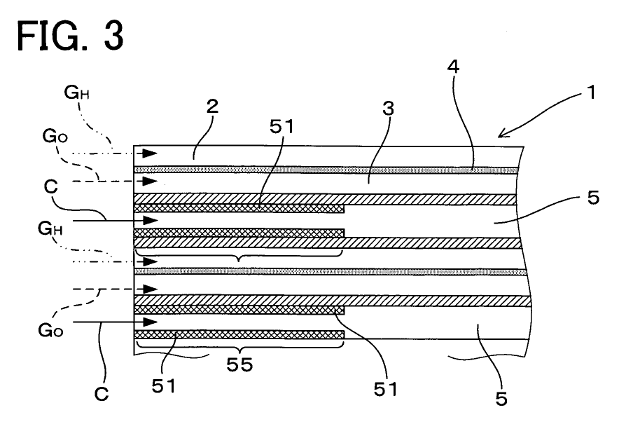

In addition, as shown in FIG. 3, in the coolant channel 5, a low heat conducting section 55 having a heat conductivity smaller than that at the downstream side is formed at the inlet side of that coolant C. In the present embodiment, the low heat conducting section 55 is formed by arranging a heat insulating layer 51 on the internal wall of the inlet side in the coolant channel 5.

Now, a fuel cell 1 according to the present embodiment will be described in detail.

As shown in FIG. 1 to FIG. 3, in the fuel cell 1 according to the present embodiment, an anode channel 2 and a cathode channel 3 are formed so as to sandwich the electrolyte 4 between these channels. In the present embodiment, the hydrogen-containing gas G_{H} obtained by reforming a hydrocarbon fuel is supplied to the anode channel 2. In addition, air serving as an oxygen-containing gas G_{O} is supplied to a cathode channel 3.

As shown in FIG. 2, the hydrogen separating metal layer 41 according to the present embodiment is made of a laminate layer of only palladium (Pd) and vanadium (V). The hydrogen separating metal layer 41 may be made of palladium, and may be made of a palladium-containing alloy. In addition, the hydrogen separating metal layer 41 has hydrogen permeability exceeding 10 A/cm² by converting to current density under a 3-atm anode gas supply condition. In this manner, an electrically conductive resistance of the hydrogen separating metal layer 41 is made to be small vanishingly.

Further, a proton conductor layer 42 according to the present embodiment is made of a perovskite-based electrolytic membrane. In addition, the electrically conductive resistance of the proton conductor layer 42 is reduced to be as small as that of a solid polymer electrolytic membrane. In addition, perovskite-based electrolytic membranes include, for example, a BaCeO₃-based membrane and a SrCeO₃-based membrane.

In addition, as shown in FIG. 2, the electrolyte 4 according to the present embodiment has an anode electrode 47 (anode) formed on a surface at the anode channel 2 in the proton conductor layer 42 and a cathode electrode 48 (cathode) formed on a surface of the cathode channel 3 in the proton conductor layer 42. In the present embodiment, the anode electrode 47 is composed of palladium that configures the hydrogen separating metal layer 41. In addition, the cathode electrode 48 is composed of a Pt-based electrode catalyst. The anode electrode can be composed of a Pt-based electrode catalyst. In the fuel cell 1 according to the present embodiment, electric energy can be acquired from these anode electrode 47 and cathode electrode 48 to the outside.

In addition, in the present embodiment, a coolant channel 5 made of stainless, for supplying a coolant, is formed between unit battery cells 15. In the present embodiment, a water steam is used as a coolant C.

In addition, as shown in FIG. 3, in the coolant channel 5 according to the present embodiment, a heat insulating layer 51 made of an aluminum oxide is formed at the inlet side of the coolant C. This heat insulating layer 51 is formed by posting a plate made of an aluminum oxide on the internal wall at the inlet side of the coolant channel 5.

Now, a operation and effect in a fuel cell 1 according to the present embodiment will be described below.

In the fuel cell 1 according to the present embodiment, as shown in FIG. 2, when a hydrogen-containing gas G_{H} is supplied to an anode channel 2, a hydrogen gas H is selectively made to permeate from the hydrogen-containing gas G_{H} by means of a hydrogen separating metal layer 41. The hydrogen gas H having permeated the hydrogen separating metal layer 41 is established in a proton (H⁺) state in a proton conductor layer 42, permeating the proton conductor layer 42. Then, the proton having permeated this proton conductor layer 42 and the oxygen-containing gas G_{O} (air) supplied to the cathode channel 3 react with each other to generate water. With this water generating reaction, as shown in FIG. 2, electric power is generated between an anode electrode 47 and a cathode electrode 48. In the fuel cell 1 according to the present embodiment, this power is externally removed, whereby electric power can be generated. In the present embodiment, a reaction in a fuel cell is carried out in a high temperature state ranging from about 300° C. to 600° C., and the water generated as described above is obtained as a water steam.

The fuel cell 1 according to the present embodiment has an electrolyte 4 made by laminating a hydrogen separating metal layer 41 and a proton conductor layer 42. Thus, in the fuel cell 1 according to the present embodiment, unlike a case in which a hydrogen separating metal and a fuel cell have been provided separately as in a conventional case, for example, hydrogen or a hydrogen-containing gas G_{H} supplied from a reformer or the like can be directly supplied to the fuel cell 1. In addition, the proton conductor layer 42 is made of ceramics, so that the fuel cell 1 according to the present embodiment can be operated in a high temperature state ranging from 300° C. to 600° C.

In addition, in the fuel cell 1 according to the present embodiment, as described above, its operating temperature can be set to a high temperature. Thus, a temperature of hydrogen or a hydrogen-containing gas G_{H} supplied from the reformer or the like and an operating temperature of the fuel cell 1 can be set to be substantially equal to each other. Therefore, there is no need for providing a heat exchanger or a condenser and the like needed due to the temperature difference between the reformer for supplying a hydrogen-containing gas and the fuel cell 1 when using the fuel cell 1 according to the present embodiment. Thus, an energy loss caused by using a heat exchanger or a condenser and the like is not generated, and a configuration of a fuel cell system can be simplified. That is, the fuel cell 1 according to the present embodiment can simplify a configuration of a fuel cell system using this battery, and its energy efficiency can be improved.

In addition, as shown in FIG. 3, in the fuel cell 1 according to the present embodiment, a heat insulating layer 51 is formed at the inlet side of a coolant C in a coolant channel 5. At a section at which this heat insulating layer 51 has been formed, heat conductivity becomes smaller than that at the downstream side in the coolant channel, and a low heat conducting section 55 is obtained.

Thus, in the fuel cell 1 according to the present embodiment, when a coolant has been supplied to the coolant channel 5, heat transfer at the inlet side can be restricted, and excessive cooling at the inlet side can be prevented. Therefore, the cooling using the coolant C in the fuel cell 1 can be uniformly carried out, and the deviation in temperature distribution can be prevented.

In addition, as shown in FIG. 2, an electrolyte 4 has a hydrogen separating metal layer 41 made of a laminate membrane of palladium and vanadium. Thus, if a deviation occurs in temperature distribution of the fuel cell 1, there is a danger that the hydrogen separating metal layer 41 composed of palladium, vanadium or the like deteriorates and battery performance is lowered. In addition, an electrically conductive resistance of the proton conductor layer 42 has temperature dependency, and increases in a low temperature region in general. Thus, there is a danger that deviating in a low temperature direction causes lowering of power generation efficiency.

However, in the fuel cell 1 according to the present embodiment, as shown in FIG. 3, the low temperature conducting section 55 is formed at the inlet side of the coolant channel 5. Thus, the deviation in temperature distribution hardly occurs, and deterioration of the hydrogen separating metal layer 41 can be prevented. In addition, no deviation in a low temperature direction occurs, and thus, the lowering of power generation efficiency can be prevented.

As described above, according to the present embodiment, there can be provided a fuel cell capable of simplifying a configuration of a fuel cell system, improving its energy efficiency and reducing the deviation in temperature distribution.

### Second Embodiment

In the present embodiment, the low heat conducting section in the coolant channel has been formed by providing a hollow section in a wall of a coolant channel.

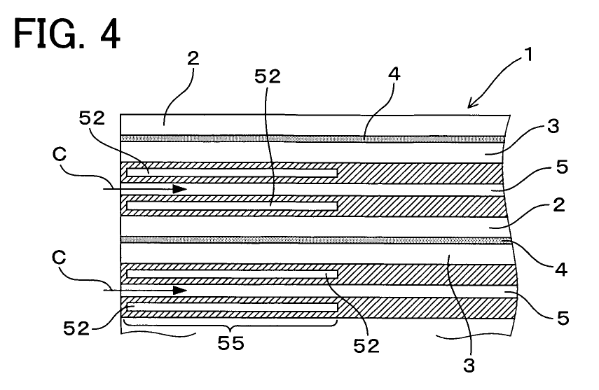

That is, as shown in FIG. 4, in the fuel cell 1 according to the present embodiment, a hollow section 52 is formed by hollowing the wall at the inlet side of the coolant channel 5 partially. In this manner, the passing heat resistance at the inlet side of the coolant channel 5 can be increased. That is, a hollow section 52 is formed in the wall at the inlet side of the coolant channel 5, whereby the inlet side of the coolant channel 5 is obtained as a configuration such as thermos, and heat transfer of this section can be restricted.

Therefore, in the fuel cell 1 according to the present embodiment, as in the first embodiment, excessive cooling at the inlet side of the coolant channel 5 can be prevented, and cooling using the coolant C can be uniformly carried out. Therefore, the deviation in temperature distribution in a fuel cell can be prevented. Other constituent elements are similar to those according to the first embodiment.

### Third Embodiment

In the present embodiment, the low heat conducting section in the coolant channel has been formed by providing a replacement restricting section.

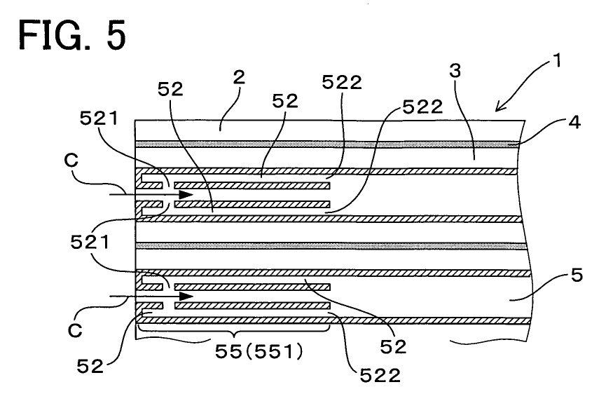

That is, as shown in FIG. 5, in the fuel cell 1 according to the present embodiment, a replacement restricting section 551 for restricting replacement of the coolant C is formed at the inlet side of the coolant channel 5, thereby forming a low heat conducting section 55. As shown in the figure, the replacement restricting section 551 is formed by providing a hollow section 52 provided in the wall at the inlet side of the coolant C in the coolant channel 5 and openings 521 and 522 provided in the hollow section 52 and opened in the coolant channel 5.

Specifically, as shown in FIG. 5, the inside of the wall at the inlet side of the coolant C in the coolant channel 5 is hollowed to form the hollow section 52, and the openings 521 and 522 that open in the coolant channel 5 are formed at hollow section 52. As shown in the figure, the openings 521 and 522 are formed so that a section positioned at the inlet side of the coolant C in the hollow section 52 and a section positioned at the downstream side open in the coolant channel 5. In particular, in the present embodiment, the opening 521 that opens in vertical to the flow of the coolant C and the opening 522 that opens parallel to the flow of the coolant C are formed. In addition, the opening 521 that opens vertical to the flow of the coolant C has been formed at the upstream side section of the flow of the coolant C, and the opening 522 that opens in parallel to the flow of the coolant C has been formed at the downstream side section of the flow of the coolant C in the hollow section 52.

As described above, at the hollow section 52, the openings 521 and 522 are provided at the inlet side of the coolant channel 5. In this manner, as shown in FIG. 5, a replacement restricting section 551 for restricting replacement of the coolant C can be formed at the inlet side of the coolant channel 5. Thus, replacement, circulation and flow of an internal gas in the coolant channel 5 can be restricted. As a result, the passing heat resistance at the inlet side of the coolant channel 5 can be increased.

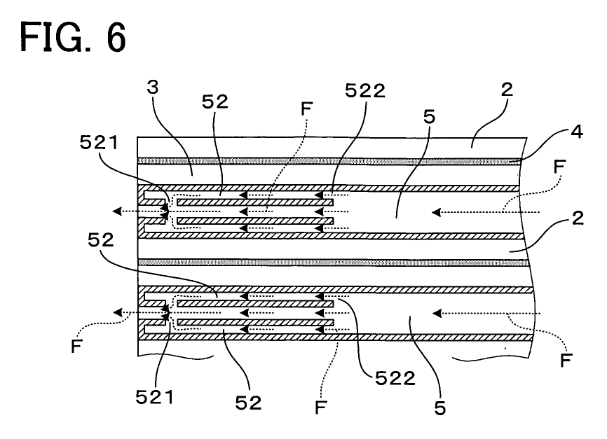

In addition, as shown in FIG. 6, in the coolant channel 5, a heating gas F can be introduced at the time of startup of the fuel cell 1. At this time, as described above, when the hollow section 52 and the openings 521 and 522 are formed, the heating gas F is supplied in an orientation in which the heating gas F is opposed to the coolant C, i.e., in an orientation opposed to the opening 522, whereby the flow of the heating gas F into the hollow section 52 is formed. As a result, the hollow section 52 can be utilized as an efficient heating fin.

That is, as shown in the figure, part of the heating gas F introduced into the coolant channel 5 in an orientation opposite to that of the coolant C flows through the coolant channel 5 in an orientation opposed to that of coolant C and is discharged from an inlet of the coolant C to the outside. On the other hand, part of the heating gas F introduced into the coolant channel 5 passes from the opening 522 through the hollow section 52, and is discharged from the opening 521 to the outside through the coolant channel 5 again.

In this manner, in the present embodiment, at the time of starting the fuel cell 1, the heating gas F is introduced into the coolant channel 5, as described above, whereby the hollow section 52 can be utilized as an efficient heating fin.

### Fourth Embodiment

In the present embodiment, a bulkhead for separating a flow of a coolant is formed and a flow channel gap between the flow channels separated by the bulkhead is changed depending on the inlet side and the downstream side of the coolant channel. In this manner, the low heat conducting section has been formed.

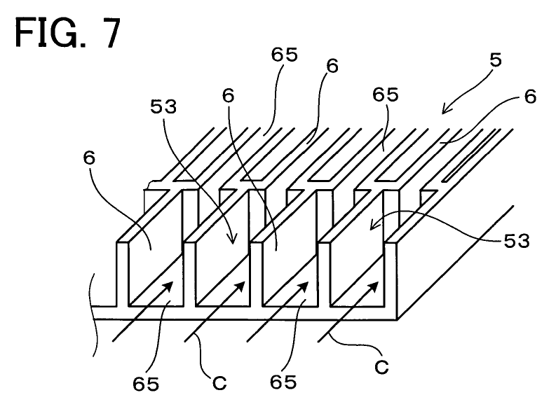

That is, in the fuel cell according to the present embodiment, as shown in FIG. 7, a plurality of bulkheads 6 for separating a flow of the coolant C are formed in the coolant channel 5. In addition, a flow channel 65 of the coolant separated by the bulkheads 6 is formed by disposing the bulkheads 6 so that a flow channel gap at the inlet side is greater than that at the downstream side. Specifically, in FIG. 7, the bulkheads 6 have been disposed so that the number of bulkheads 6 at the inlet side of the coolant channel 5 is smaller than that at the downstream side. In this manner, a flow channel expanding section 53 whose flow channel gap is greater than that at the downstream side is formed at the inlet side of the flow channel 65 separated by the bulkheads 6.

Therefore, in the present embodiment, when the coolant C is supplied to the coolant channel 5, the coolant C is dispersed into the coolant channel 5 by means of the bulkheads 6 so that the internal flow distribution of the coolant C and the deviation due to gravity can be prevented. Therefore, uniform cooling can be achieved.

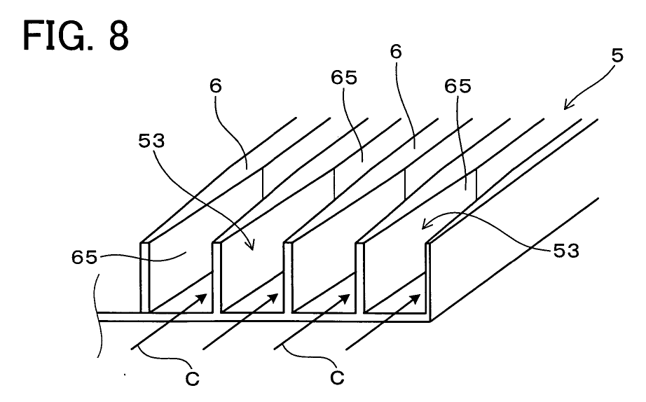

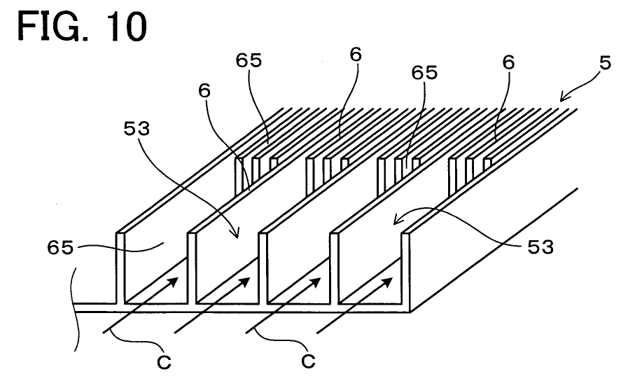

In addition, as described above, the flow channel expanding section 53 is formed at the inlet side of the coolant C, and the flow channel 65 separated by the bulkhead 6 has its sectional area becoming large at the inlet side, thus reducing a heat transmission area of this section. In this manner, the heat conductivity at the inlet side in the coolant channel 5 can be lowered, and the low heat conducting section can be easily formed in the coolant channel 5. In FIG. 7, FIG. 8, and FIG. 10 to FIG. 12 described later, only sections of coolant channels in a fuel cell are indicated in a perspective view in order to explicitly depict a configuration of the bulkheads in the coolant channel.

In addition, the flow channel expanding section 53, as shown in FIG. 8, can be formed by reducing the thickness of the bulkhead 6 at the inlet side of the coolant channel 5 and increasing the thickness at the downstream side. That is, in the present embodiment, as shown in the figure, a section disposed at the inlet side of the coolant channel 5 on the bulkhead 6 is inclined so that the thickness at the inlet side is reduced. In this manner, in the flow channel 65 separated by the bulkheads 6, a flow channel gap at the inlet side becomes greater than that at the downstream side, and the flow channel expanding section 53 can be formed at the inlet side. Then, even in the case where the flow channel expanding section 53 has been thus formed, the heat conductivity at the inlet side of the coolant C in the coolant channel 5 can be reduced. In addition, the low heat conducting section can be easily formed in the coolant channel 5.

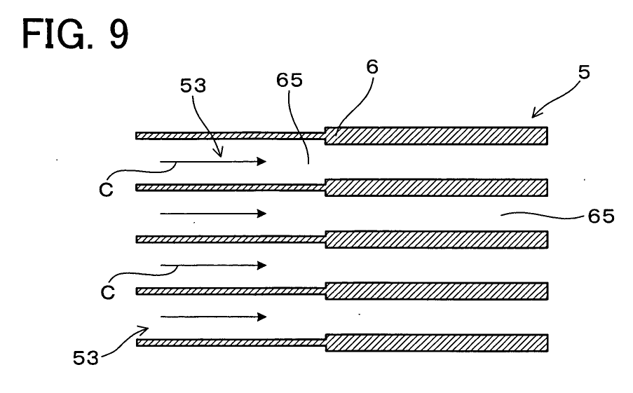

In addition, in the case where a flow channel expanding section is formed by changing the thickness of the bulkheads, protrusive bulkheads 6 can be disposed so that the thickness of the bulkhead 6 at the inlet side is smaller than that at the downstream side, as shown in FIG. 9. In this case as well, in the flow channel 65 separated by the bulkheads 6, a flow channel gap at the inlet side becomes greater than that at the downstream side, and the flow channel expanding section 53 can be formed at the inlet side. In FIG. 9, there is shown a plan view when the coolant channel 5 is seen from above in order to explicitly indicate a change in thickness of the bulkhead 6.

In addition, a flow channel expanding section at the inlet side of a coolant channel can be formed by disposing a bulkheads 6 extending from its inlet side to the downstream side in the coolant channel 5 and further adding and disposing a bulkhead 6 at only a section at more downstream side than its inlet in a flow channel 65 separated by this bulkhead 6, as shown in FIG. 10. In this case as well, the number of bulkheads 6 at the inlet side is less than that at the downstream side. In the flow channel 65 separated by the bulkhead 6, a flow channel gap at its inlet side becomes greater than that at the downstream side. That is, a flow channel expanding section 53 is formed at the inlet side. Then, even in the case where the flow channel expanding section 53 has been thus formed, heat conductivity at the inlet side in the coolant channel 5 can be lowered, and the low heat conducting section can be easily formed in the coolant channel 5.

In addition, the flow channel expanding section can be formed at only part of the flow channels separated by the bulkheads.

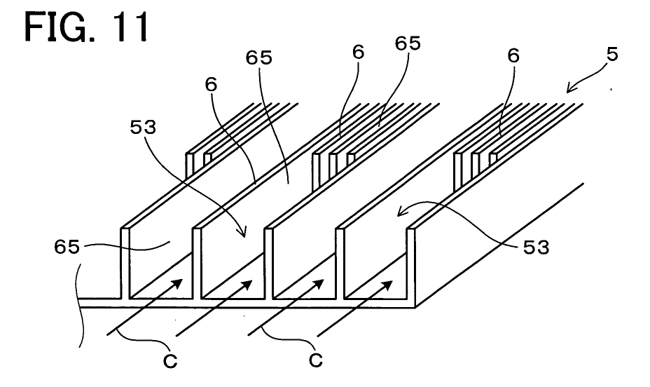

That is, as shown in FIG. 11, in one or more flow channels 65 from among the flow channels 65 separated by the bulkheads 6, a bulkhead 6 is further added to its downstream side, and a flow channel expanding section 53 is formed. On the other hand, a bulkhead 6 is not added and disposed to the remaining flow channels from among the flow channels 65 separated by the bulkheads 6. The bulkhead 6 is thus disposed, whereby a flow channel having a flow channel expanding section 53 and a flow channel that does not have a flow channel expanding section 53 can be obtained in the flow channel 65 separated by the bulkhead 6.

When the flow channel expanding section 53 is formed in all of the flow channels 65 separated by the bulkheads 6, there is a danger that a pressure loss increases when the coolant C has been supplied. Therefore, as described above, the flow channel expanding section 53 is formed at only one or more of the flow channels 65 separated by the bulkheads 6. In this manner, an excessive cooling prevention effect caused by forming the flow channel expanding section 53 can be obtained while an increase in pressure loss is reduced to the minimum.

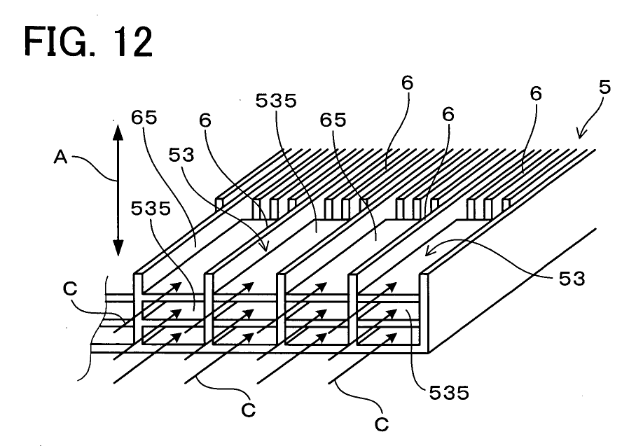

In addition, as shown in FIG. 12, at a flow channel expanding section 53, there can be formed a separating wall 535 for separating the flow channel expanding section 53 in a direction substantially vertical to a laminate direction A of an anode channel, a cathode channel and a coolant channel.

That is, as shown in the figure, a bulkhead 6 extending from its inlet side to the downstream side is disposed in the coolant channel 5. In addition, a bulkhead 6 is further added to only the downstream side from its inlet in the flow channel 65 separated by the bulkhead 6, thereby forming the flow channel expanding section 53 at the inlet side of the flow channel 65. Then, at this flow channel expanding section 53, there are formed a plurality of separating walls 535 for separating the flow channel expanding section 53 in a direction substantially vertical to the laminate direction A of the anode channel, the cathode channel, and the electrolyte. In FIG. 12, although the anode channel, the cathode channel, and the electrolyte are not shown, its laminate direction is shown in the arrow A.

The separating wall 535 is thus formed, whereby a heat flow direction, i.e., a heat flow in the laminate direction A can be restricted; a temperature difference in a face substantially vertical to the heat flow direction can be reduced; and excessive cooling at the inlet side in the coolant flow direction 5 can be prevented.

### Fifth Embodiment

In the present embodiment, the low heat conducting section has been formed by forming a communicating section on the bulkhead at the inlet side of the coolant channel.

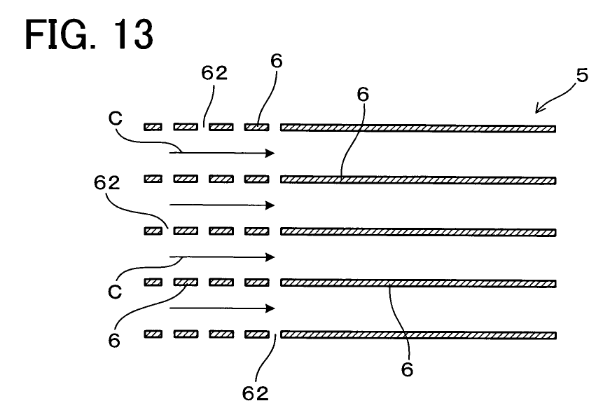

That is, in the present embodiment, as shown in FIG. 13, a bulkhead 6 for separating a flow of a coolant C is formed in a coolant channel 5 and a communicating section 62 is formed at a section at the inlet side of the coolant channel 5 in the bulkhead 6. In FIG. 13, the communicating section 62 is formed by disposing a bulkhead 6 so that the bulkhead 6 at the inlet side is spaced in a flowing direction of a coolant.

Therefore, in the present embodiment, a heat transmission area at the inlet side of the coolant channel 5 can be reduced. As a result, an expanded heat transmission area at the inlet side can be reduced. That is, in this case, the low heat conducting section can be easily formed at the inlet side of the coolant channel 5. FIG. 13 shows a plan view when a coolant channel 5 is seen from above in order to explicitly indicate that a bulkhead 6 is spaced at the inlet side of the coolant channel 5.

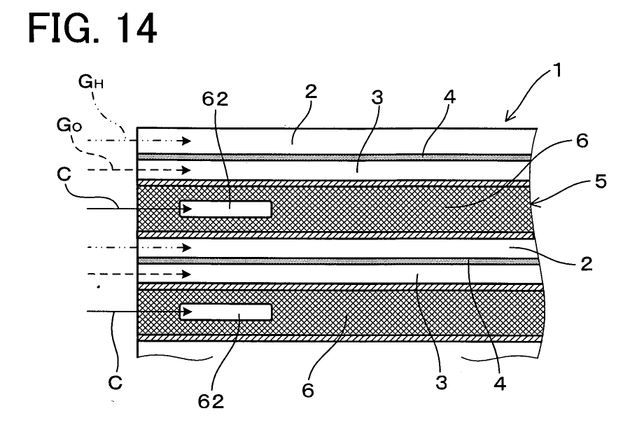

In addition, as shown in FIG. 14, a communicating section 62 can be formed on the bulkhead 6 by providing a slit in a flow direction of that coolant C. In this case, a fin internal heat flux in a heat flow direction is broken by means of a slit so that a heat transmission area can be reduced.

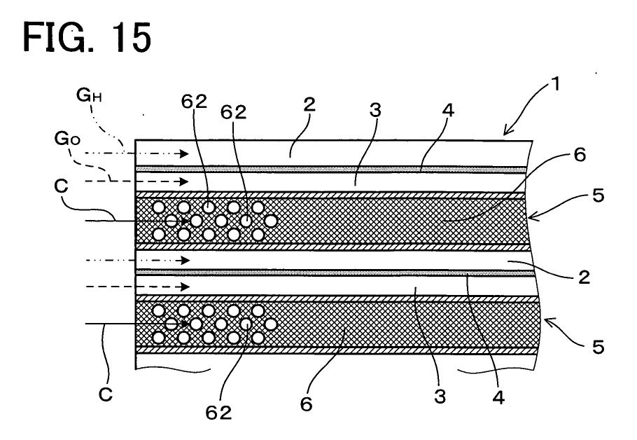

Further, as shown in FIG. 15, the communicating section 62 can also be formed by forming a plurality of holes on the bulkhead 6. In this case, the fin internal heat flux in the heat flow direction is broken by the holes provided on the bulkhead 6 so that a heat transmission area can be reduced.

In FIG. 14 and FIG. 15, there is shown a sectional view when a fuel cell 1 is seen from a side face in order to explicitly indicate a slit and a hole provided on the bulkhead 6.

### Sixth Embodiment

In the present embodiment, at the inlet side of the coolant channel, the low heat conducting section has been formed by forming a spaced section between a bulkhead and an internal wall of a coolant channel.

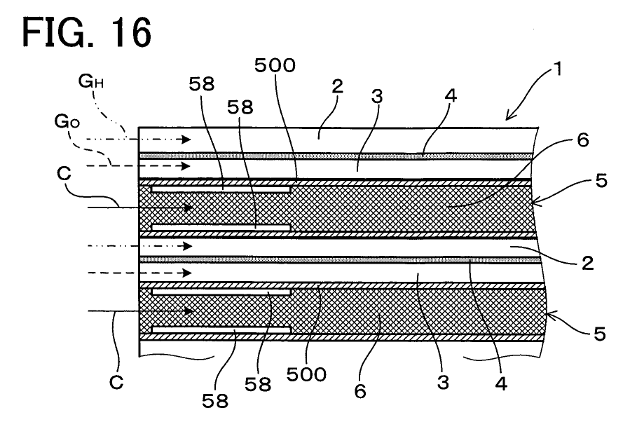

That is, in the present embodiment, as shown in FIG. 16, a bulkhead 6 for separating a flow of a coolant C in a coolant channel 5 is formed. In addition, at the inlet side of the coolant channel 5, a spaced section 58 for a bulkhead 6 to be spaced from an internal wall 500 of the coolant channel 5 is formed at least a part of a section at which the bulkhead 6 and the internal call 500 of the coolant channel 5 come into contact with each other.

Therefore, in the coolant channel 5 according to the present embodiment, the fin internal heat flux at its inlet side is broken so that the fin efficiency at the inlet side of the coolant channel 5 can be reduced. As a result, an actual heat transmission area can be reduced, and heat transmission property at the inlet side of the coolant channel 5 can be lowered. That is, the low heat conducting section can be easily formed at the inlet side of the coolant channel 5. In FIG. 16, there is shown a sectional view when a fuel cell 1 is seen from above in order to explicitly indicate a spaced section 58 provided between the bulkhead 6 and the internal wall 500 of the coolant channel 5.

### Seventh Embodiment

In the present embodiment, a section at the inlet side of the coolant channel on the bulkhead has been formed of a low heat conducting material.

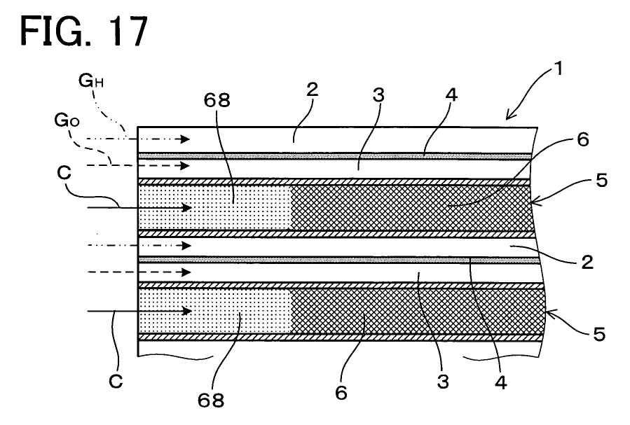

That is, in the present embodiment, as shown in FIG. 17, a bulkhead 6 for separating a flow of a coolant C is formed in a coolant channel 5. In addition, a section 68 at the inlet side of the coolant channel 5 of the bulkhead 6 is formed of a low heat conducting material having a lower heat conductivity than that at the downstream side. In the present embodiment, aluminum oxide has been used as a low heat conducting material.

A section 68 at the inlet side of a bulkhead is thus formed of a low heat conducting material, whereby fin efficiency at the inlet side of the coolant channel can be reduced. As a result, the heat conducting area at the inlet side can be reduced, and heat conductivity can be lowered. That is, in this case, the low heat conducting section can be easily formed at the inlet side of the coolant channel 5. In FIG. 17, there is shown a sectional view when a fuel cell 1 is seen from a side face in order to explicitly indicate that the bulkhead 6 is partially composed of a low heat conducting material. In addition, in FIG. 17, there is shown a section 68 composed of a low heat conducting material on the bulkhead 6 while hatching is changed.

### Eighth Embodiment

In the present embodiment, a side face inlet for introducing a coolant has been formed on a side face of a coolant channel.

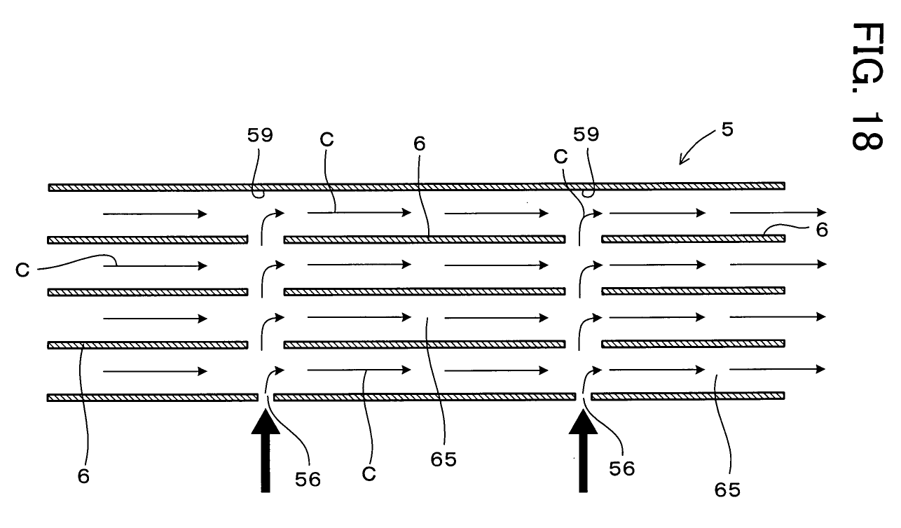

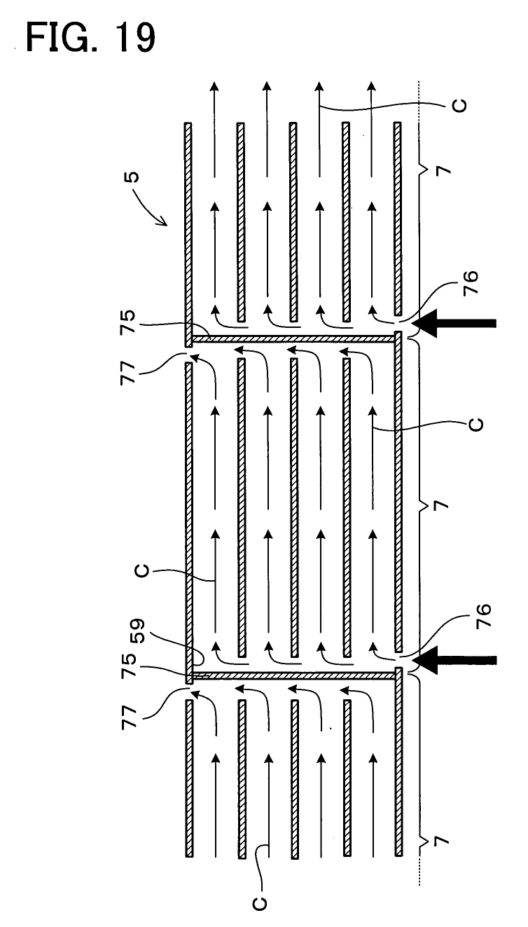

That is, as shown in FIG. 18, in a coolant channel 5 according to the present embodiment, a plurality of side face inlets 56 for introducing a coolant C are formed on a side face of the coolant channel. The side face inlets 56 are formed at more downstream side than the inlet side of the coolant channel. FIG. 18 and FIG. 19 which are described later show plan views when a coolant channel 5 is seen from above in order to clarify a flow of a coolant C in the coolant channel 5. In addition, in FIG. 18 and FIG. 19, although an anode channel, a cathode channel, and an electrolyte are not shown, a direction vertical to paper face designates a laminate direction of these elements.

In the present embodiment, a coolant C can be also introduced from the side face inlet 56 formed on a side face at the downstream side in the coolant channel 5. In addition, the coolant C introduced from the side face inlet 56 flows while it joins with the coolant from the inlet side of the coolant channel 5. That is, the coolant channel 5 can be provided as a serial flow channel. Thus, in the coolant channel 5 according to the present embodiment, a coolant flow rate at the downstream side can be increased. That is, at the inlet side (upstream side) of the coolant channel 5, a coolant flow rate is reduced more significantly than that at the downstream side so that the cooling speed at the inlet side can be lowered. In addition, the lowering off the heat transmissibility at the inlet side can be promoted.

In addition, a plurality of bulkheads 6 are disposed in the coolant channel 5 according to the present embodiment. In addition, the bulkheads 6 are arranged so as to advance or retract in the flowing direction of the coolant C more significantly than a perpendicular line drawn from the side face inlet to the internal wall 59 of the coolant channel opposites to the side face inlet so that the coolant C introduced from the side face inlet 56 flows while the coolant is separated by the bulkheads 6. That is, as shown in FIG. 18, the bulkhead 6 is not formed on a line connecting between the internal wall 59 of the coolant channel opposed to the side face inlet 56 and the side face inlet 56. In addition, the coolant C introduced from the side face inlet 56 flows while the coolant is distributed to the flow channel 65 separated by the bulkhead 6 in the coolant channel 5. Therefore, the coolant C introduced from the side face inlet 56 flows while the coolant is dispersed in the coolant channel, enabling cooling that is almost free from deviation.

### Ninth Embodiment

In the present embodiment, a coolant channel has been partitioned into a plurality of units.

That is, as shown in FIG. 19, the coolant channel 5 according to the present embodiment has a partition wall 75 for partitioning the flowing direction of the coolant C into a plurality of units 7. In addition, in each of the units 7, there are arranged an introducing inlet 76 for introducing a coolant and an exhaust outlet 77 for discharging a coolant.

The coolant channel 5 is thus formed in a plurality of the units 7 having the introducing inlet 76 and the exhaust outlet 77, whereby a parallel flow channel can be formed as a coolant channel 5. In addition, each of the coolant units 7 can supply and discharge the coolant C independently so that the temperature distribution in the coolant channel 5 can be arbitrarily set. Specifically, for example, a coolant flow rate at the inlet side of the coolant channel 5 in which excessive cooling is likely to occur, can be reduced or a coolant flow rate at the downstream side at which cooling is hardly achieved can be increased. A coolant flow rate in each of the units 7 is thus controlled, whereby the heat conductivity at the inlet side of the coolant channel 5 can be reduced. In this manner, the low heat conducting section can be easily formed at the inlet side of the coolant channel 5.

In addition, in the present embodiment, as shown in FIG. 19, a plurality of bulkheads 6 are disposed in each of the units 7. Then, the bulkheads 6 are arranged so as to advance in the flowing direction of the coolant C more significantly than a perpendicular line drawn to the internal wall 59 of the coolant channel opposite to the introducing inlet 76 so that the coolant C introduced from the introducing inlet 76 is separated by the bulkheads 6. That is, as shown in FIG. 19, the bulkheads 6 are not formed on a line connecting the internal wall 59 of the coolant channel opposite to the introducing inlet 76 and the introducing inlet 76. In addition, at the exhaust outlet 77 as well, the bulkheads 6 are not formed on a line connecting the exhaust outlet and the internal wall opposite thereto so that the coolant C separated by the bulkhead 6 is discharged from the exhaust outlet 77 while the coolant joins with another coolant.

### Tenth Embodiment

In the present embodiment, an interrupt wall has been formed in at least one or more of the flow channels separated by bulkheads.

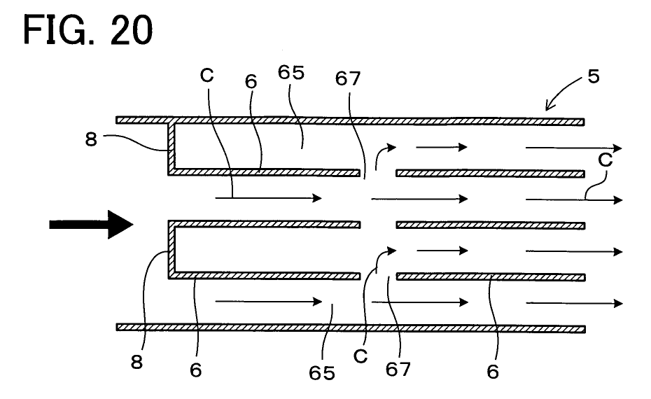

That is, as shown in FIG. 20, in the coolant channel 5 according to the present embodiment, there are arranged a plurality of bulkheads 6 for separating a flow of a coolant C in a coolant channel 5. In addition, in one or more of the flow channels 65 separated by the bulkhead 6, an interrupt wall 8 for interrupting a flow of a coolant C is arranged at its inlet side.

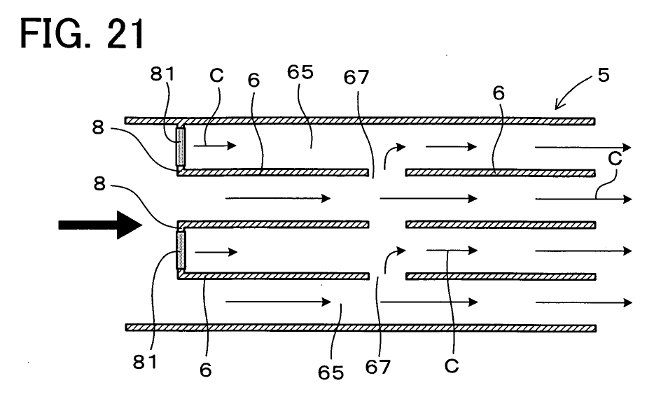

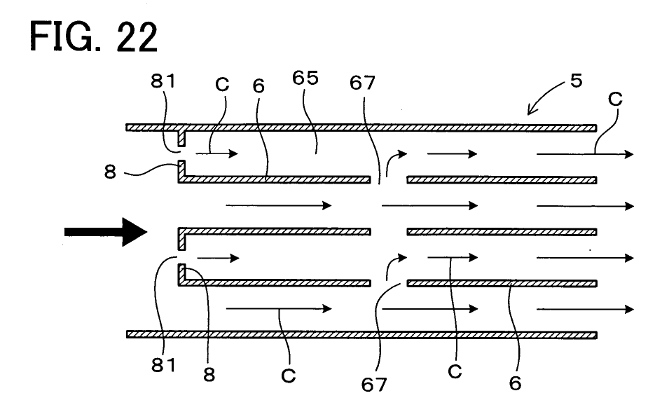

Therefore, a flow channel in which a coolant C flows and a flow channel in which no coolant C flows are formed at the inlet side of the coolant channel 5 according to the present embodiment. Thus, even if the coolant C is introduced into the coolant channel 5, the coolant C does not flow to one or more of the flow channels at its inlet side. As a result, heat exchange capability at the inlet side of the coolant channel can be lowered. In FIG. 20, FIG. 21 and FIG. 22 described later, there are shown plan views when a coolant channel 5 is seen from above in order to explicitly indicate an interrupt wall 8.

In addition, as shown in FIG. 20, in the coolant channel 5 according to the present embodiment, communicating hole 67 is formed on the bulkhead 6. This insert hole 67 is formed at more downstream side than the inlet side of the coolant C in the coolant channel 5. Thus, at the inlet side, a coolant does not flow to a flow channel forming an interrupt wall 65. However, at the downstream side more than the inlet side, the coolant C passes through the communicating hole 65, and flows in a redistributed manner.

In the case of forming the interrupt wall 65, there is a danger that the flow of the coolant C at the downstream side of the coolant channel 5 becomes non-uniform and that the deviation in temperature distribution occurs at the downstream side. However, in the coolant channel 5 according to the present embodiment, as described above, a communicating hole 67 for re-distributing a coolant is provided at a section at the downstream side of the bulkhead 67 so that the flow of the coolant can be prevented from being non-uniform at the downstream side. As a result, the uniformed temperature distribution at the downstream side of the coolant channel can be promoted.

In addition, in the present embodiment, a flow rate restricting section for restricting a coolant flow rate and making a coolant permeate can be formed on at least a part of the interrupt wall.

That is, as shown in FIG. 21, a flow rate restricting section 81 for restricting a flow rate of a coolant C and permeating the coolant C has been formed on at least a part of an interrupt wall 8. This flow rate restricting section 81 can be formed by ensuring that at least a part of the interrupt wall 8 is formed of a coolant resistance material. In the present embodiment, a porous material made of stainless has been used as a coolant resistance material.

Thus, when the coolant C is introduced into the coolant channel 5 according to the present embodiment, a flow channel in which a large coolant flow rate exists and a flow channel in which a small coolant flow rate exists are formed at the inlet side of the coolant C. In this manner, the heat exchange capability at the inlet side of the coolant channel 5 can be reduced, and the low heat conducting section can be easily formed.

In addition, in this case as well, a communicating hole 67 for redistributing a coolant is provided at a section at the downstream side of the bulkhead 67, wherein the flow of the coolant C can be prevented from being non-uniform at the downstream side.

In addition, as shown in FIG. 22, a flow rate restricting section 81 can be formed by forming a collimating hole on at least at a part of the interrupt wall 8.

That is, as shown in the figure, in the coolant channel 5 according to the present embodiment, a collimating hole for passing a small amount of a coolant is formed on at least a part of the interrupt wall 8. In this case as well, a flow channel in which a large coolant flow rate exists and a flow channel in which a small coolant flow rate exists are formed at the inlet side of the coolant C in the coolant channel 5. Thus, the heat exchange capability at the inlet side of the coolant channel 5 can be reduced.

In addition, in this case as well, a communicating hole 67 for redistributing a coolant is provided at a section of the downstream side of the bulkhead 6, whereby the flow of the coolant C can be prevented from being non-uniform at the downstream.

### Eleventh Embodiment

In the present embodiment, a coolant channel has been formed of a single flow channel without forming a bulkhead in the coolant channel.

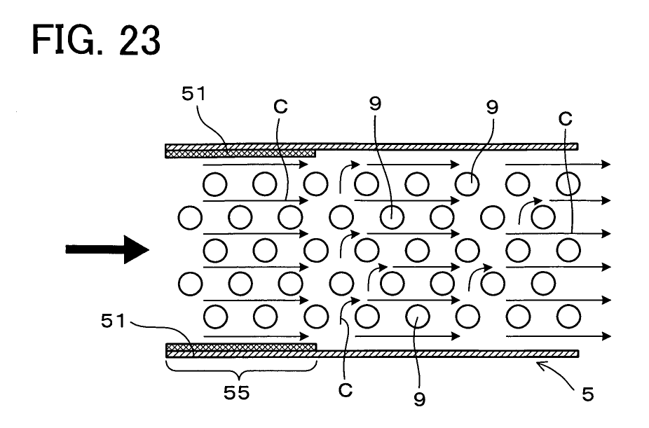

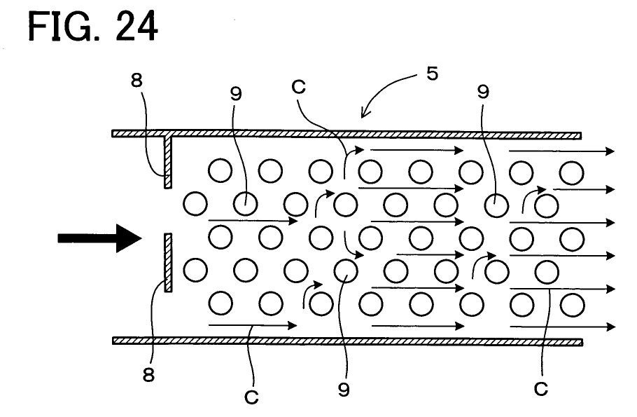

That is, in the present embodiment, as shown in FIG. 23, a coolant channel 5 is composed of a single flow channel, and the bulkheads as described in the fourth to tenth embodiments are not formed. In FIG. 23 and FIG. 24 to FIG. 26 that are described later, there are plan views when a coolant channel 5 is seen from above in order to explicitly indicate that a bulkhead 6 is not formed in the coolant channel 5.

In addition, a plurality of protrusions 9 that protrude from the internal wall to the inside of the coolant channel 5 are formed inside of the coolant channel 5. These protrusions 9 are formed integrally with the internal wall of the coolant channel 5. In addition, in the present embodiment, in order to form a low heat conducting section 55 at the inlet side of a coolant channel 5, as in the first embodiment, a heat insulating layer 51 made of aluminum oxide is formed on the internal wall of the inlet side.

The coolant channel 5 according to the present embodiment is composed of a single flow channel, as described above, so that the internal flow distribution in the coolant channel can be made uniform.

That is, as in the fourth to tenth embodiments described above, when a bulkhead is formed in a coolant channel, there is a danger that the flow of the coolant becomes non-uniform and that the deviation in temperature distribution occurs at the downstream side of the coolant.

As described in the present embodiment, a coolant channel 5 is composed of a single flow channel, whereby this non-uniformity can be resolved.

In addition, in the coolant channel 5 according to the present embodiment, a plurality of protrusions 9 are formed in the coolant channel. Thus, the coolant C introduced into the coolant channel 5 flows while the coolant C is dispersed uniformly in the coolant channel 5 by this protrusions 9.

In addition, in the present embodiment, a heat insulating layer 51 similar to that according to the first embodiment is formed on the internal wall at the inlet side of the coolant channel 5. Therefore, heat transfer at the inlet side of the coolant channel 5 is restricted, whereby the low heat conducting section 55 can be easily formed at the inlet side of the coolant channel.

Further, in the present embodiment, an interrupt wall similar to that of the ninth embodiment can be formed at the inlet side of the coolant channel. That is, as shown in FIG. 23, in the coolant channel 5 according to the present embodiment made of a single flow channel as well, an interrupt wall 8 for partially interrupting a flow of a coolant C can be formed at its inlet side.

The interrupt wall 8 is thus formed, whereby a section at which no coolant flows can be formed at the inlet side of the coolant channel 5. Then, in this manner, the heat exchange capability at the inlet side of the coolant channel 5 can be lowered.

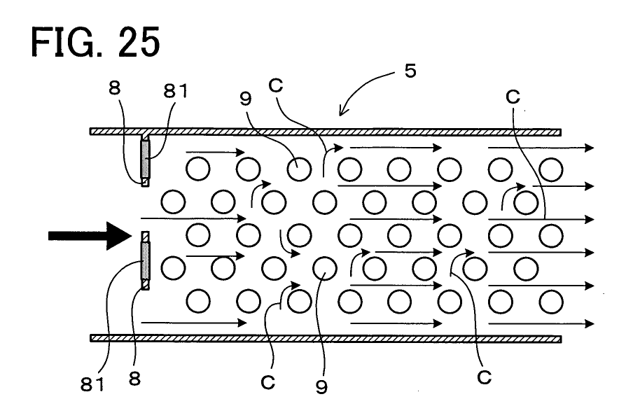

In addition, as shown in FIG. 25, a flow rate restricting section 81 for restricting a flow rate of a coolant and making the coolant permeate can be formed at least at a part of the interrupt wall 5. This flow rate restricting section 81 can be formed by ensuring that part of the interrupt wall 8 is formed of a coolant resistance material that is similar to that according to the ninth embodiment.

Thus, when the coolant C is introduced into the coolant channel 5, a section at which a large coolant flow rate exists and a section at which a small coolant flow rate exists are formed at the inlet side of the coolant channel 5. The heat exchange capability at the inlet side of the coolant channel 5 can be reduced.

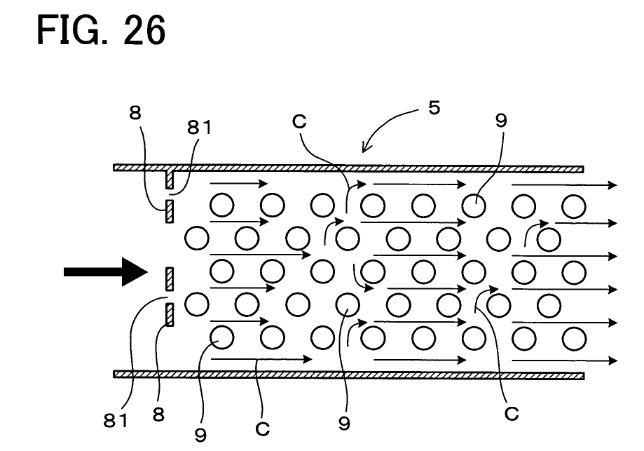

In addition, as shown in FIG. 26, the flow rate restricting section 81 can be formed by ensuring that a collimating hole is formed on at least at a part of the interrupt wall 8, as in the ninth embodiment.

In this case as well, a section at which a large coolant flow rate exists and a section at which a small coolant flow rate exists can be formed at the inlet side of the coolant C in the coolant channel 5. Thus, the heat exchange capability at the inlet side of the coolant channel 5 can be reduced.

Obviously, numerous modifications and variations of the present invention are possible in light of the above teachings. It is therefore to be understood that, within the scope of the appended claims, the invention may be practiced otherwise than as specifically described here.

What is claimed is:

1. A fuel cell comprising a laminate of:
an anode channel supplied with hydrogen or a hydrogen-containing gas;
a cathode channel supplied with oxygen or an oxygen-containing gas; and
an electrolyte arranged between the cathode channel and the anode channel,
wherein the electrolyte is made by laminating: a hydrogen separating metal layer for being permeated by hydrogen supplied to the anode channel or hydrogen in a hydrogen-containing gas supplied to the anode channel; and a proton conductor layer made of ceramics, for establishing the hydrogen having permeated the hydrogen separating metal layer in a proton state and making the proton reach the cathode channel;
wherein the fuel cell has a coolant channel for cooling the fuel cell, and, at an inlet side of the coolant in the coolant channel, a low heat conducting section whose heat conductivity is smaller than that at a downstream side thereof is formed; and
wherein the low heat conducting section is formed by providing a replacement restricting section for restricting replacement of a coolant at an inlet side of the coolant channel.

2. A fuel cell as claimed in claim 1, wherein the replacement restricting section is formed by providing a hollow section provided in a wall at an inlet side of a coolant in the coolant channel and an opening that is provided at the hollow section and that opens in the coolant channel.

3. A fuel cell as claimed in claim 2, wherein the opening is formed so that a section positioned at an inlet side of a coolant in the hollow section and a section positioned at a downstream side in the hollow section open into the coolant channel.

4. A fuel cell comprising a laminate of:
an anode channel supplied with hydrogen or a hydrogen-containing gas;
a cathode channel supplied with oxygen or an oxygen-containing gas; and
an electrolyte arranged between the cathode channel and the anode channel,
wherein the electrolyte is made by laminating: a hydrogen separating metal layer for being permeated by hydrogen supplied to the anode channel or hydrogen in a hydrogen-containing gas supplied to the anode channel; and a proton conductor layer made of ceramics, for establishing the hydrogen having permeated the hydrogen separating metal layer in a proton state and making the proton reach the cathode channel;
wherein the fuel cell has a coolant channel for cooling the fuel cell, and, at an inlet side of the coolant in the coolant channel, a low heat conducting section whose heat conductivity is smaller than that at a downstream side thereof is formed; and
wherein the coolant channel has a side face inlet for introducing a coolant from a side face of a downstream side thereof.

5. A fuel cell comprising a laminate of:
an anode channel supplied with hydrogen or a hydrogen-containing gas;
a cathode channel supplied with oxygen or an oxygen-containing gas; and
an electrolyte arranged between the cathode channel and the anode channel,
wherein the electrolyte is made by laminating: a hydrogen separating metal layer for being permeated by hydrogen supplied to the anode channel or hydrogen in a hydrogen-containing gas supplied to the anode channel; and a proton conductor layer made of ceramics, for establishing the hydrogen having permeated the hydrogen separating metal layer in a proton state and making the proton reach the cathode channel;
wherein the fuel cell has a coolant channel for cooling the fuel cell, and, at an inlet side of the coolant in the coolant channel, a low heat conducting section whose heat conductivity is smaller than that at a downstream side thereof is formed; and
wherein the coolant channel has a partition wall for partitioning a coolant flowing direction into a plurality of units, and wherein an introducing inlet for introducing a coolant and an exhaust outlet for discharging a coolant are arranged at each unit, respectively.

6. A fuel cell as claimed in claim 1, wherein, in the coolant channel, bulkheads for separating a flow of a coolant are arranged in substantial parallel to a coolant flowing direction.

7. A fuel cell as claimed in claim 6, wherein flow channels of the coolant separated by the bulkheads comprise a flow channel expanding section formed so that a flow channel gap at an inlet side thereof is greater than that at a downstream side thereof.

8. A fuel cell as claimed in claim 7, wherein the flow channel expanding section is formed in one or more of the flow channels separated by the bulkheads, and the flow channel expanding section is not formed in the remaining ones of the separated flow channels.

9. A fuel cell as claimed in claim 7, wherein, at the flow channel expanding section, a separating wall for separating the flow channel expanding section is formed in a direction substantially vertical to a laminate direction of the anode channel, the cathode channel, and the electrolyte.

10. A fuel cell as claimed in claim 6, wherein the bulkhead has a communicating section that communicates the flow channels separated by the bulkheads at an inlet side of the coolant channel.

11. A fuel cell as claimed in claim 6, wherein, at an inlet side of the coolant channel, a spaced section at which the bulkhead is spaced from an internal wall of the coolant channel is formed at least at a part of a section at which the bulkhead and the internal wall of the coolant channel come into contact with each other.

12. A fuel cell as claimed in claim 6, wherein a section at an inlet side of a coolant channel on the bulkhead is configured so that a heat conductivity of the section is lower than that at a section at a downstream side thereof.

13. A fuel cell as claimed in claim 6, wherein, at least at one or more of flow channels separated by the bulkheads, an interrupt wall for interrupting a flow of a coolant is arranged at an inlet side of the coolant channel.

14. A fuel cell as claimed in claim 13, wherein a flow rate restricting section for restricting a flow rate of a coolant and making the coolant permeate is formed at least at a part of the interrupt wall.

15. A fuel cell as claimed in claim 13, wherein a communicating hole for redistributing a coolant is provided at a section that exists at a downstream side of the coolant channel on the bulkhead.

16. A fuel cell as claimed in claim 1, wherein the coolant channel is formed of a single flow channel.

17. A fuel cell as claimed in claim 16, wherein an interrupt wall for interrupting part of a flow of a coolant is arranged at an inlet side of the coolant channel in the coolant channel.

18. A fuel cell as claimed in claim 17, wherein a flow rate restricting section for restricting a flow rate of a coolant and making the coolant permeate is formed on at least at a part of the interrupt wall.

19. A fuel cell as claimed in claim 1, wherein the coolant channel has a side face inlet for introducing a coolant from a side face of a downstream side thereof.

20. A fuel cell as claimed in claim 1, wherein the coolant channel has a partition wall for partitioning a coolant flowing direction into a plurality of units, and wherein an introducing inlet for introducing a coolant and an exhaust outlet for discharging a coolant are arranged at each unit, respectively.
